(19) United States
(12) Patent Application Publication
(10) Pub. No.: US 2026/0267650 A1
(43) Pub. Date: Sep. 10, 2026

(54) LOW-POWER OPERATIONS USING LEADING ZERO COUNT

(71) Applicant: Apple Inc., Cupertino, CA (US)

(72) Inventors: Fatemeh KASHFI, San Diego, CA (US); Michael L. LIU, Palo Alto, CA (US); Joseph RABINOWICZ, Even Yehuda (IL)

(21) Appl. No.: 19/075,555

(22) Filed: Mar. 10, 2025

(51) Int. Cl. G06F 9/38; G06F 9/30

(52) U.S. Cl. CPC G06F 9/3832; G06F 9/30021

(57) ABSTRACT

An arithmetic-compare circuit that includes a first logic circuit and a second logic circuit is disclosed. The first logic circuit may perform an arithmetic-compare operation using a first operand, a second operand, and a third operand. The second logic circuit may determine respective leading-zero counts for the first operand, the second operand and the third operand, and predict a result of the arithmetic-compare operation using the respective leading zero counts. The first logic circuit may be disabled based on the predicted result.

### FIELD

This disclosure relates to the field of integrated circuit implementation and, more particularly, to the implementation of arithmetic-compare operations.

### BACKGROUND

Modern computer systems include multiple circuit blocks designed to perform various functions. For example, such circuit blocks may include processors or processor cores configured to execute software or program instructions. Additionally, the circuit blocks may include memory circuits, mixed-signal or analog circuits, and the like.

Some circuit blocks in a computer system convert analog input signals to digital signals that can be analyzed by processor circuits. For example, analog data from one or more sensors, e.g., a temperature sensor, can be converted to digital signals that a processor circuit can use to regulate power consumption within the computer system.

In some computer systems, dedicated processor circuits may be used to process certain types of data. For example, in some cases, image processor circuits may perform various transformation or other processing on data received from one or more image sensors included in a computer system.

### BRIEF DESCRIPTION OF THE DRAWINGS

FIG. 1 is a block diagram depicting an embodiment of an arithmetic-compare circuit.

FIG. 2 is a block diagram depicting an embodiment of a logic circuit that includes an arithmetic circuit and a compare circuit.

FIG. 3 is a block diagram depicting an embodiment of a logic circuit that includes leading zero counter circuits.

FIG. 4 is a block diagram depicting an embodiment of a leading zero counter circuit.

FIG. 5 is a block diagram depicting an embodiment of a computer system that includes an image processor circuit.

FIG. 6 is a flow diagram depicting an embodiment of a method for performing arithmetic-compare operations.

FIG. 7 is a flow diagram depicting an embodiment of a method for performing arithmetic-compare operations with mixed-sign operands.

FIG. 8 is a block diagram of an embodiment of a device that may include analog circuits.

FIG. 9 is a block diagram of various embodiments of computer systems that may include analog circuits.

FIG. 10 illustrates an example of a non-transitory computer-readable storage medium that stores circuit design information.

### DETAILED DESCRIPTION

Computer systems can include a variety of circuits. Some circuits may perform analog functions such as generating power supply voltage levels. Other circuits can perform various digital functions. For example, a computer system may include circuits that perform logical operations, e.g., AND, OR, invert, etc., on one or more digital words. In addition to performing logical operations, a computer system may include circuits that perform arithmetic operations such as addition and multiplication.

Circuits designed to perform multiplication and other arithmetic operations can consume large amounts of power as well as area on an integrated circuit. In some situations, however, such arithmetic operations are only to be used in conjunction with a compare operation in which the output of the arithmetic operation is being compared to another number. The result of the comparison may be used to determine a remaining portion of a logic operation.

During some signal operations, various signals are compared to a noise threshold. Many signal values are less than the noise threshold most of the time. If a result of this type of comparison could be predicted earlier in the logic operation, then other portions of the overall operation could be disabled to save dynamic power.

The embodiments illustrated in the drawings and described below provide techniques for predicting a result of an arithmetic-compare operation using a number of leading logical-0s in the operands. By predicting an outcome of the operation, the arithmetic portion of the operation can be disabled in some situations, thereby saving dynamic power.

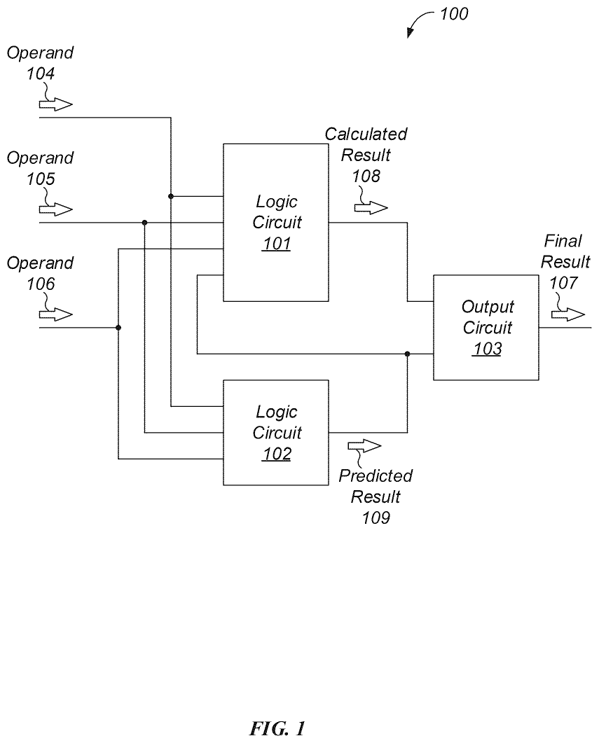

A block diagram of an embodiment of an arithmetic-compare circuit is depicted in FIG. 1. As illustrated, arithmetic-compare circuit 100 includes logic circuit 101, logic circuit 102, and output circuit 103.

Logic circuit 101 is configured to perform an arithmetic-compare operation using operand 104, operand 105, and operand 106. In various embodiments, to perform the arithmetic-compare operation, logic circuit 101 is configured to perform an arithmetic portion of the arithmetic-compare operation using operand 104 and operand 105, and then compare a result of the arithmetic portion of the operation to operand 106 to generate calculated result 108.

Operands 104-106 may, in some embodiments, be integers. In other embodiments, operands 104-106 may be fixed-point numbers, floating-point numbers, or any other suitable number format.

Logic circuit 102 is configured to determine respective leading-zero counts for operands 104-106. Additionally, logic circuit 102 is configured to generate predicted result 109 using the respective leading-zero counts. In some embodiments, predicted result 109 may correspond to a result of the arithmetic-compare operation. In various embodiments, logic circuit 102 may be further configured to disable, using predicted result 109, an execution of the arithmetic-compare operation. In some cases, to disable the execution of the arithmetic-compare operation, logic circuit 102 may be further configured to disable logic circuit 101.

Output circuit 103 is configured to generate final result 107 using calculated result 108 and predicted result 109. As described below, to generate final result 107, output circuit 103 may be further configured to select one of calculated result 108 or predicted result 109 using leading-one indices of operand 104, operand 105, and operand 106.

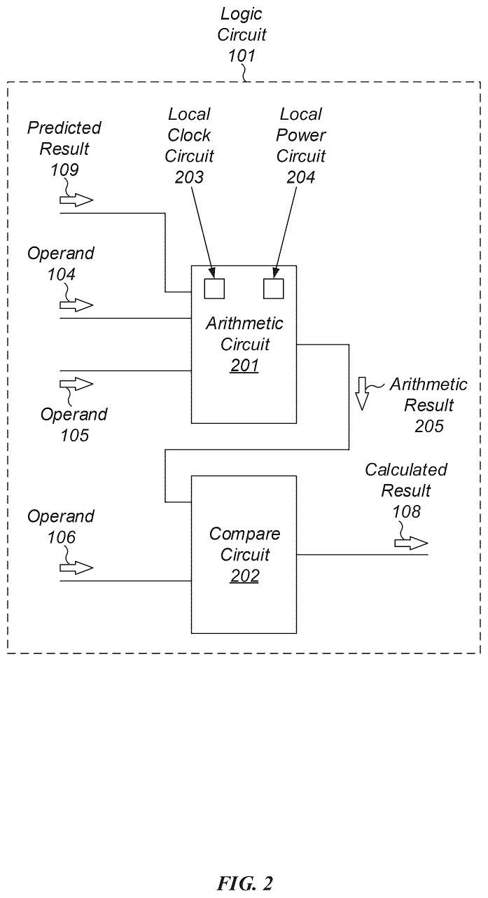

Turning to FIG. 2, a block diagram of an embodiment of logic circuit 101 is depicted. As illustrated, logic circuit 101 includes arithmetic circuit 201 and compare circuit 202.

Arithmetic circuit 201 is configured to generate arithmetic result 205 using operand 104, operand 105, and predicted result 109. In various embodiments, to generate arithmetic result 205, arithmetic circuit 201 is further configured, in response to a determination that predicted result 109 is not valid, to combine operand 104 and operand 105 to generate arithmetic result 205. In some embodiments, to combine operand 104 and operand 105, arithmetic circuit 201 can be configured to multiply operand 104 and operand 105, or divide operand 104 by operand 105.

In various embodiments, to generate arithmetic result 205, arithmetic circuit 201 is further configured, in response to a determination that predicted result 109 is valid, to disable an execution of the arithmetic-compare operation. To disable the execution of the arithmetic-compare operation, arithmetic circuit 201 is further configured to activate local clock circuit 203 or local power circuit 204. In some embodiments, local clock circuit 203 may be configured to gate a clock signal to arithmetic circuit 201 to prevent execution of the arithmetic operation. In other embodiments, local power circuit 204 may be configured to disconnect at least a portion of arithmetic circuit 201 from a power supply rail to prevent execution of the arithmetic operation.

Compare circuit 202 is configured to generate calculated result 108 using arithmetic result 205 and operand 106. In various embodiments, to generate calculated result 108, compare circuit 202 may be further configured to compare a value of arithmetic result 205 to a value of operand 106. In response to a determination that operand 106 is less than arithmetic result 205, compare circuit 202 may be configured to set calculated result 108 to a particular value. In response to a determination that operand 106 is greater than arithmetic result 205, compare circuit 202 may be configured to set calculated result 108 to another value, different than the particular value. In response to a determination that operand 106 is equal to arithmetic result 205, compare circuit 202 may be configured to set calculated result 108 to another value, different than other particular values.

In various embodiments, arithmetic circuit 201 and compare circuit 202 may be implemented using any suitable combination of sequential and/or combinatorial logic gates. In some cases, arithmetic circuit 201 may include a dedicated multiplier circuit, or division circuit.

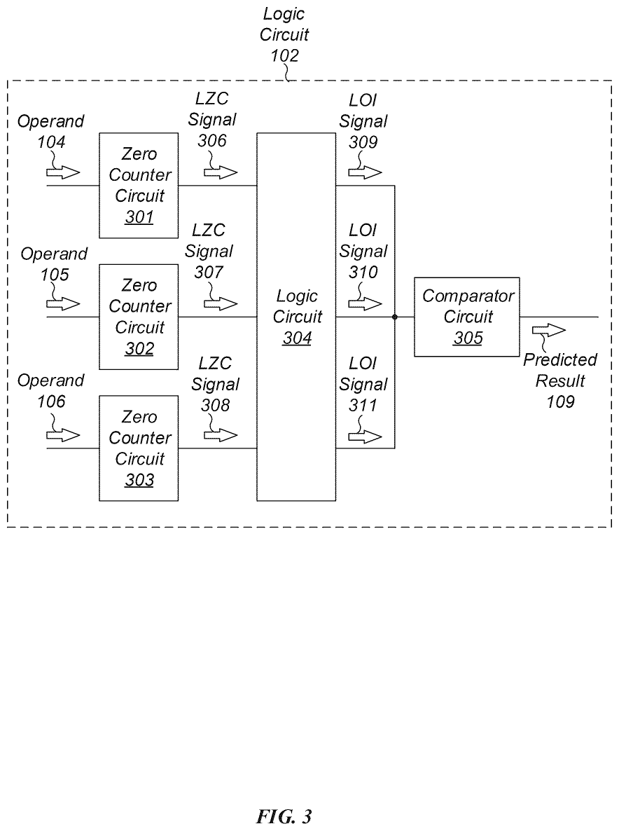

Turning to FIG. 3, a block diagram of an embodiment of logic circuit 102 is depicted. As illustrated, logic circuit 102 includes zero counter circuits 301-303, logic circuit 304, and comparator circuit 305.

Zero counter circuit 301 is configured to generate LZC (Leading Zero Count) signal 306 using operand 104. In a similar fashion, zero counter circuit 302 is configured to generate LZC signal 307 using operand 105, and zero counter circuit 303 is configured to generate LZC signal 308 using operand 106. In various embodiments, LZC signals 306-308 encode information indicative of a number of zeros at the most-significant-bit end of operands 104-106, respectively. As described below, zero counter circuits 301-303 may be implemented using multiple combinatorial logic gates.

Logic circuit 304 is configured to generate LOI (Leading-One Index) signals 309-311 using LZC signals 306-308. As used herein, a leading-one index refers to a value indicative of a location where a first logical-1 value occurs in a most-significant-bit end of an operand. In a similar fashion, a leading-zero index refers to a value indicative of a location where a first logical-0 occurs in a most-significant-bit end of an operand. For example, LOI signals 309-311 may encode information indicative of an index where the first logical-1 value occurs in operands 104-106, respectively at the most-significant-bit end of operands. In various embodiments, a leading-one index or a leading-zero index may include any suitable number of bits to encode a location of first logical-1 or a first logical-0, respectively.

In some embodiments, logic circuit 304 may determine LOI signals 309-311 using the respective number of bits in operands 104-106. In some embodiments, a given one of LOI signals 309-311 may be determined according to equation 1, wherein n is the number of bits in a corresponding one of operands 104-106, and LZC is a leading zero count for the corresponding one of operands 104-106.

$$LOI = n - 1 - LZC \qquad ( 1 )$$

Comparator circuit 305 is configured to generate predicted result 109 using LOI signals 309-311. In cases where the arithmetic-compare operation includes multiplication, to generate predicted result 109, comparator circuit 305 may be configured to combine LOI signal 309 and LOI signal 310 according to equation 2, where LOI_{P} is an intermediate leading one index, LOI₃₀₉ is a value of LOI signal 309, and LOI₃₁₀ is a value of LOI signal 310. It is noted that, in some embodiments, LOI_{P} may include adding one to equation 2 based on a value of an overflow bit.

$${LOI}_{P} = {LOI}_{309} + {LOI}_{310} \qquad ( 2 )$$

In cases where the arithmetic-compare operation includes a division operation, to generate predicted result 109, comparator circuit 305 may be configured to combine LOI signal 309 and LOI signal 310 according to equation 3, where LOI_{P} is an intermediate leading one index, LOI₃₀₉ is a value of LOI signal 309, and LOI₃₁₀ is a value of LOI signal 310. It is noted that, in some embodiments, LOI_{P} may include subtracting one to equation 3 based on a value of an overflow bit.

$${LOI}_{P} = {LOI}_{309} - {LOI}_{310} \qquad ( 3 )$$

In various embodiments, comparator circuit 305 may be configured to compare LOI_{P} with LOI signal 311. In response to a determination that LOI_{P} is greater than LOI signal 311, comparator circuit 305 may set predicted result 109 to a value indicating the product of operand 104 and 105 is greater than operand 106. Alternatively, in response to a determination that LOI_{P} is less than LOI signal 311, comparator circuit 305 may set predicted result 109 to a value indicating the product of operand 104 and operand 105 is less than operand 106. If LOI_{P} is equal to LOI signal 311, logic circuit 102 cannot predict whether the product of operand 104 and operand 105 is less than, greater than, or equal to operand 106, and logic circuit 201 needs to perform the full arithmetic operation.

It is noted that comparator circuit 305 may, in other embodiments, combine LOI signals 309-311 in different ways to generate predicted result 109. In various embodiments, comparator circuit 305 may be implemented using any suitable combination of sequential and/or combinatorial logic gates.

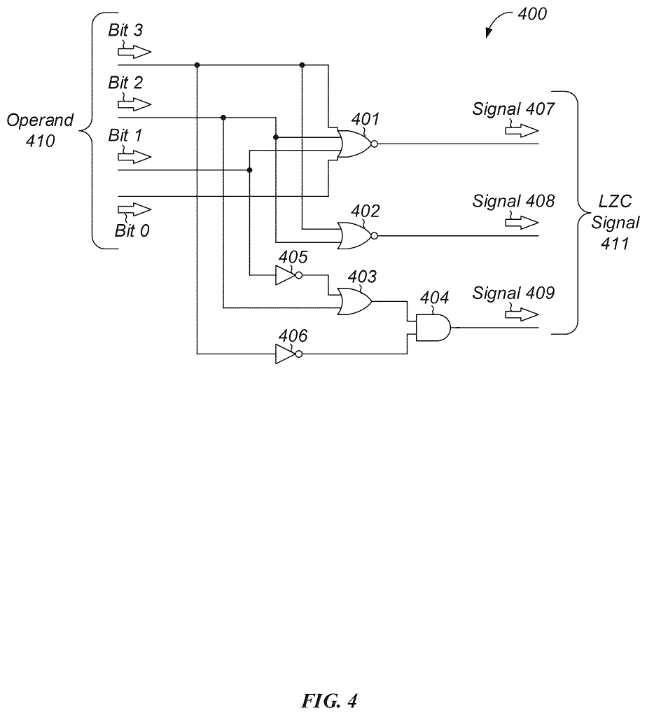

Turning to FIG. 4, a block diagram of an embodiment of a leading zero counter circuit is depicted. As illustrated, leading zero counter circuit 400 includes NOR gates 401 and 402, OR gate 403, AND gate 404, and inverters 405 and 406. In some embodiments, leading zero counter circuit 400 may correspond to any of zero counter circuits 301-303 as depicted in FIG. 3.

NOR gate 401 is configured to generate signal 407 using bits 0-3 of operand 410. In some embodiments, operand 410 may correspond to any of operands 104-106. Although operand 410 is depicted as including 4 bits, in other embodiments, operand 410 can include any suitable number of bits. To generate signal 407, NOR gate 401 may be further configured to combine bits 0-3 using a logical-NOR operation. In some cases, a logical-1 value for signal 407 may correspond to a case where operand 410 does not contain any logical-1 values.

NOR gate 402 is configured to generate signal 408 using bits 3 and 2 of operand 410. Inverter 405 is configured to generate an inverse of bit 1 of operand 410, while inverter 406 is configured to generate an inverse of bit 3 of operand 410. OR gate 403 is configured to combine bit 2 of operand 410 and the inverse of bit 1 of operand 410 from inverter 405. AND gate 404 is configured to generate signal 409 using the output of OR gate 403 and the output of inverter 406.

Signals 407-409 may encode a number corresponding to an index or location of a first occurrence of a logical-1 in operand 410. In various embodiments, signals 407-409 may collectively be included in LZC signal 411. In some cases, LZC signal 411 may correspond to any of LZC signals 306-308.

It is noted that the embodiment of leading zero counter circuit 400 depicted in FIG. 4 is merely an example. In other embodiments, different techniques and combinations of logic gates may be employed to determine a number of leading zeros in a particular operand.

The embodiments depicted in FIGS. 1-4 are for processing unsigned or positive integer operands. In other embodiments, the operands may be negative integers or floating point numbers. In the case of negative integer operands, rather than using a number of leading zeros, arithmetic-compare circuit 100 may be configured to use leading ones to make a prediction of an arithmetic-compare operation.

In addition to being configured to perform arithmetic-compare operations using all positive operands, and all negative operands, arithmetic-compare circuit 100 may be further configured to perform arithmetic-compare operations using a mix of both positive and negative operands.

To perform a mixed-sign comparison, arithmetic-compare circuit 100 may be further configured to determine respective signals of operands 104-106, and predict, using a first sign of operand 104 and a second sign of operand 105, a sign of an arithmetic portion of an arithmetic-compare operation. In various embodiments, the arithmetic portion of the arithmetic-compare operation can include a multiplication operation or a division operation. Arithmetic-compare circuit 100 may be further configured to perform a comparison of the sign of the arithmetic portion of the arithmetic-compare operation to a third sign of operand 106, and disable, using a result of the comparison, an execution of the arithmetic-compare operation.

In some embodiments, arithmetic-compare circuit 100 is configured to predict a result of the arithmetic-compare operation in response to a determination that the sign of the arithmetic portion of the arithmetic-compare operation is positive and that the third sign of operand 106 is negative. Alternatively, or additionally, arithmetic-compare circuit 100 may be further configured to predict a result of the arithmetic-compare operation in response to a determination that the sign of the arithmetic portion of the arithmetic-compare operation is negative and that the third sign of the operand 106 is positive.

In various embodiments, arithmetic-compare circuit 100 is also configured, in response to a determination that that the sign of the arithmetic portion of the arithmetic-compare operation is positive and that the third sign of operand 106 is positive, to determine respective leading-zero counts for operand 104, operand 105, and operand 106, and predict, using respective leading-zero counts for operands 104-106, a first result of an arithmetic-compare operation.

In other embodiments, arithmetic-compare circuit 100 can be configured, in response to a determination that that the sign of the arithmetic portion of the arithmetic-compare operation is negative and that the third sign of operand 106 is negative, to determine, in response to a determination that the first sign of the operand 104 is positive, a leading-zero count for the operand 104, determine, in response to a determination that the second sign of operand 105 is negative, a first leading-one count for the operand 105, determine a second leading-one count for the operand 106, and predict, using the leading-zero count, the first leading-one count, and the second leading-one count, a first result of an arithmetic-compare operation.

In other embodiments, arithmetic-compare circuit 100 can be configured, in response to a determination that that the sign of the arithmetic portion of the arithmetic-compare operation is negative and that the third sign of operand 106 is negative, to determine, in response to a determination that the first sign of the operand 104 is negative, a first leading-one count for the operand 104, determine, in response to a determination that the second sign of operand 105 is positive, a leading-zero count for the operand 105, determine a second leading-one count for the operand 106, and predict, using the leading-zero count, the first leading-one count, and the second leading-one count, a first result of an arithmetic-compare operation.

In some embodiments, arithmetic-compare circuit 100 can be configured, in response to a determination that that the sign of the arithmetic portion of the arithmetic-compare operation is positive and that the third sign of operand 106 is positive, to determine, in response to a determination that the first sign of operand 104 is negative, a first leading-one count for operand 104, determine, in response to a determination that the second sign of operand 105 is negative, a second leading-one count for operand 105, determine a leading-zero count for operand 106, and predict, using the leading-zero count, the first leading-one count, and the second leading-one count, a first result of an arithmetic-compare operation.

The techniques described above can further be extended to floating-point numbers. As used herein, a floating point numbers includes sign, exponent, and mantissa bits. In the case of floating point numbers, a leading-one index can be determined from the exponent. For positive floating-point numbers, the leading-one index is equal to the exponent value in both the case of an explicit one and an implicit one in the mantissa. It is noted that if the exponent includes a bias (as in the IEEE-754 format) the bias has to be removed in order to determine the leading-one index. In a multiply-and-compare operation with three floating-point operands, depending on an overflow bit, the sum of the exponents, or the sum of the exponents plus one, of the multiplier inputs can be compared with an exponent of the comparison operand to predict a result of the comparison and disable the multiply-and-compare operation.

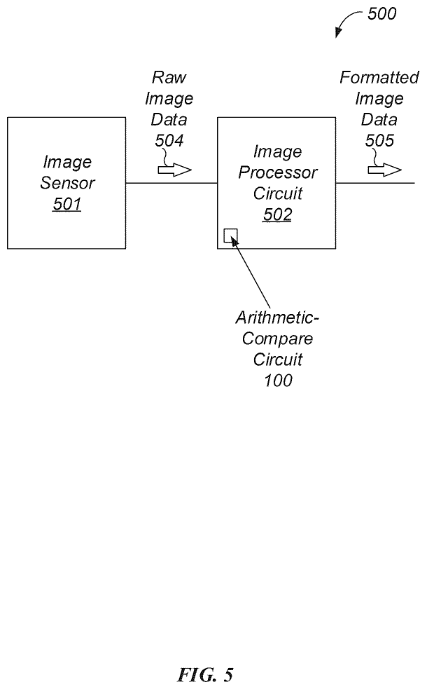

Turning to FIG. 5, a block diagram of a computer system is depicted. As illustrated, computer system 500 includes image sensor 501 and image processor circuit 502. It is noted that computer system 500 may, in other embodiments, include other circuit blocks that have been omitted from FIG. 5 for clarity.

Image sensor 501 is configured to generate raw image data 504. In various embodiments, image sensor 501 may be implemented using a charge-coupled device, an active-pixel sensor, or any other suitable type of sensor circuit.

Image processor circuit 502, which includes one or more instances of arithmetic-compare circuit 100, is configured to generate formatted image data 505 using raw image data 504. For example, image processor circuit 502 may be configured to perform demosaicing, noise reduction, image sharpening, or any other suitable image processing algorithm. It is noted that, in some embodiments, image processor circuit 502 may be used to process other image data, not just that provided by image sensor 501. By utilizing the one or more instances of arithmetic-compare circuit 100, image processor circuit 502 can perform multiply-and-compare and other arithmetic-compare operations that consume less power.

To summarize, various embodiments of an arithmetic-compare circuit are disclosed. Broadly speaking, the arithmetic-compare circuit includes a first logic circuit that may be configured to determine respective leading-zero counts for a first operand, a second operand and a third operand, and predict a result of an arithmetic-compare operation using the respective leading zero counts. The arithmetic-compare circuit further includes a second logic circuit that may be configured to disable, using the result, an execution of the arithmetic-compare operation.

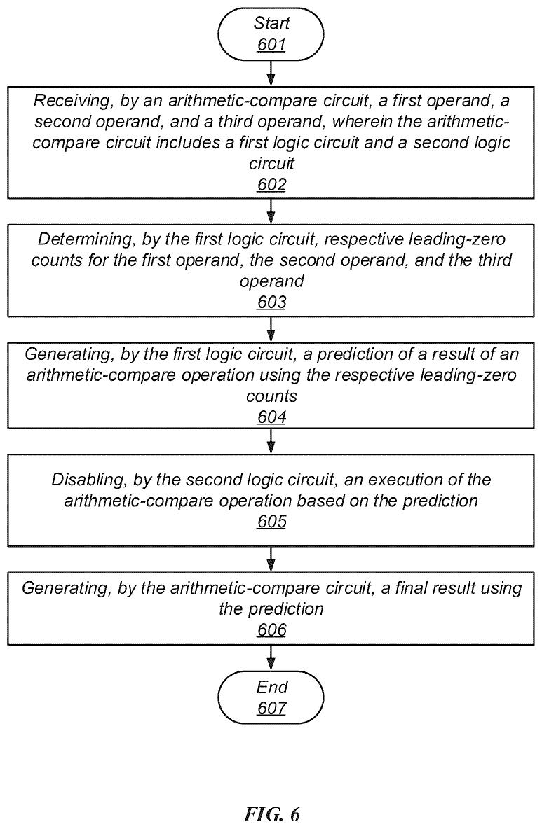

Turning to FIG. 6, a flow diagram depicting an embodiment of a method for performing an arithmetic-compare operation is illustrated. The method, which may be applied to various arithmetic-compare circuits, e.g., arithmetic-compare circuit 100 as depicted in FIG. 1, begins in block 601.

The method include receiving, by an arithmetic-compare circuit, a first operand, a second operand, and a third operand (block 602). In various embodiments, the arithmetic-compare circuit includes a first logic circuit and a second logic circuit.

The method further includes determining, by the first logic circuit, respective leading-zero counts for the first operand, the second operand, and the third operand (block 603). In some embodiments, the method may further include determining, by the first logic circuit, a first leading-one index using a first leading-zero count, determining, by the first logic circuit, a second leading-one index using a second leading-zero count, and determining, by the first logic circuit, a third leading-one index using a third leading-zero count.

The method also includes generating, by the first logic circuit, a prediction of a result of an arithmetic-compare operation using the respective leading-zero counts (block 604). In some embodiments, generating the prediction includes combining, by the first logic circuit, the first leading-one index and the second leading-one index to generate an index sum, and performing, by the first logic circuit, a comparison of the index sum and the third leading-one index. In other embodiments, generating the prediction includes combining, by the first logic circuit, the first leading-one index and the second leading-one index to generate an index different, and performing, by the first logic circuit, a comparison of the index different and the third leading-one index.

The method further includes disabling, by the second logic circuit, an execution of the arithmetic-compare operation based on the prediction (block 605). In some embodiments, disabling the execution of the arithmetic-compare operation includes performing, by the first logic circuit, a comparison of the index sum, which is the combination of first leading-one index and the second leading-one index with the third leading one index, and disabling, by the second logic circuit, the execution of the arithmetic-compare operation using a result of the comparison.

The method also includes generating, by the arithmetic-compare circuit, a final result using the prediction (block 606). In some embodiments, the method further includes performing, by the first logic circuit, a comparison of the index sum and the third leading-one index, and performing, by the second logic circuit, the arithmetic-compare operation in response to determining the index sum is equal to the third leading-one index. In such cases, the method also includes generating, by the arithmetic-compare circuit, the final result using a calculated result of the arithmetic-compare operation.

In some embodiments, performing the arithmetic-compare operation includes multiplying, by the second logic circuit, the first operand and the second operand to generate a product, and comparing, by the second logic circuit, the product and the third operand to generate the calculated result. In other embodiments, performing the arithmetic-compare operation includes dividing, by the second logic circuit, the first operand by the second operand to generate a quotient, and comparing, by the second logic circuit, the quotient and the third operand to generate the calculated result. The method concludes in block 607.

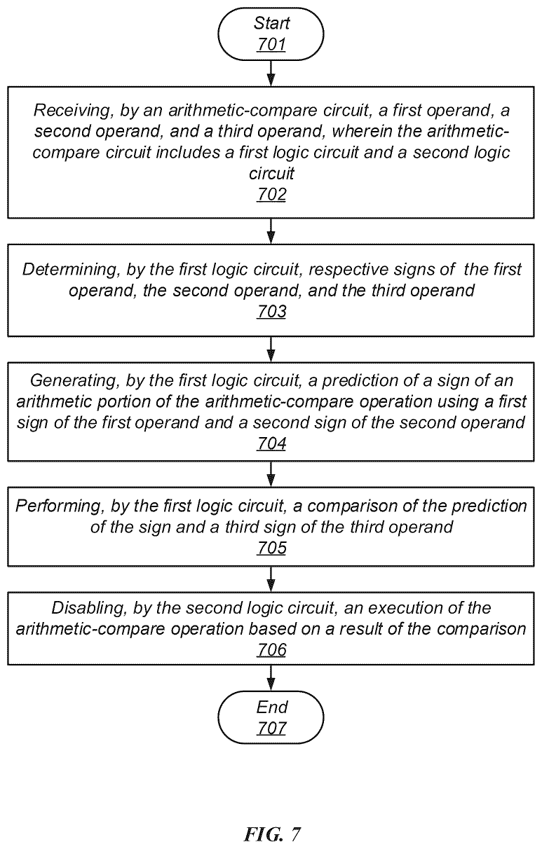

Turning to FIG. 7, a flow diagram depicting an embodiment of a method for performing an arithmetic-compare operation with mixed-sign operands is illustrated. The method, which may be applied to various arithmetic-compare circuits, e.g., arithmetic-compare circuit 100 as depicted in FIG. 1, begins in block 701.

The method include receiving, by an arithmetic-compare circuit, a first operand, a second operand, and a third operand (block 702). In various embodiments, the arithmetic-compare circuit includes a first logic circuit and a second logic circuit, and the first operand, the second operand, and the third operand can be either positive or negative numbers.

The method further includes determining, by the first logic circuit, respective signs of the first operand, the second operand, and the third operand (block 703). In various embodiments, determining the respective signs of the first operand, the second operand, and the third operand includes checking respective sign bits included in the first operand, the second operand, and the third operand.

The method also includes generating, by the first logic circuit, a prediction of a sign of an arithmetic portion of the arithmetic-compare operation using a first sign of the first operand and a second sign of the second operand (block 704). In various embodiments, generating the prediction of the sign of the arithmetic portion includes combining respective sign bits of the first operand the second operand.

The method further includes performing, by the first logic circuit, a comparison of the prediction of the sign and a third sign of the third operand (block 705). In some embodiments, the method includes predicting a result of the arithmetic-compare operation in response to a determination that the sign of the arithmetic portion of the arithmetic-compare operation is positive and that the third sign of the third operand is negative. In other embodiments, the method includes predicting a result of the arithmetic-compare operation in response to a determination that the sign of the arithmetic portion of the arithmetic-compare operation is negative and that the third sign of the third operand is positive.

In some cases, the method includes, in response to determining that that the sign of the arithmetic portion of the arithmetic-compare operation is positive and that the third sign of the third operand is positive, determining respective leading-zero counts for a first operand, a second operand and a third operand, and predicting, using respective leading-zero counts for the first operand, the second operand, and the third operand, a first result of an arithmetic-compare operation.

In other cases, the method can include, in response to determining that that the sign of the arithmetic portion of the arithmetic-compare operation is negative and that the third sign of the third operand is negative, determining, in response to a determination that the first sign of the first operand is positive, a leading-zero count for the first operand, determining, in response to a determination that the second sign of the second operand is negative, a first leading-one count for the second operand, determining a second leading-one count for the third operand, and predicting, using the leading-zero count, the first leading-one count, and the second leading-one count, a first result of an arithmetic-compare operation.

In other cases, the method can include, in response to determining that that the sign of the arithmetic portion of the arithmetic-compare operation is negative and that the third sign of the third operand is negative, determining, in response to a determination that the first sign of the first operand is negative, a first leading-one count for the first operand, determining, in response to a determination that the second sign of the second operand is positive, a leading-zero count for the second operand, determining a second leading-one count for the third operand, and predicting, using the leading-zero count, the first leading-one count, and the second leading-one count, a first result of an arithmetic-compare operation.

In some embodiments, the method includes, in response to determining that that the sign of the arithmetic portion of the arithmetic-compare operation is positive and that the third sign of the third operand is positive, determining, in response to a determination that the first sign of the first operand is negative, a first leading-one count for the first operand, determining, in response to a determination that the second sign of the second operand is negative, a second leading-one count for the second operand; determining a leading-zero count for the third operand, and predicting, using the leading-zero count, the first leading-one count, and the second leading-one count, a first result of an arithmetic-compare operation.

The method also includes disabling, by the second logic circuit, an execution of the arithmetic-compare operation based on the prediction (block 706). In some embodiments, disabling the execution of the arithmetic-compare operation includes performing, by the first logic circuit, a comparison of the index sum, which is the combination of first leading-zero index (or leading-one index) and the second leading-zero index (or leading-one index) with the third leading-zero index (or leading-one index), and disabling, by the second logic circuit, the execution of the arithmetic-compare operation using a result of the comparison. The method concludes in block 707.

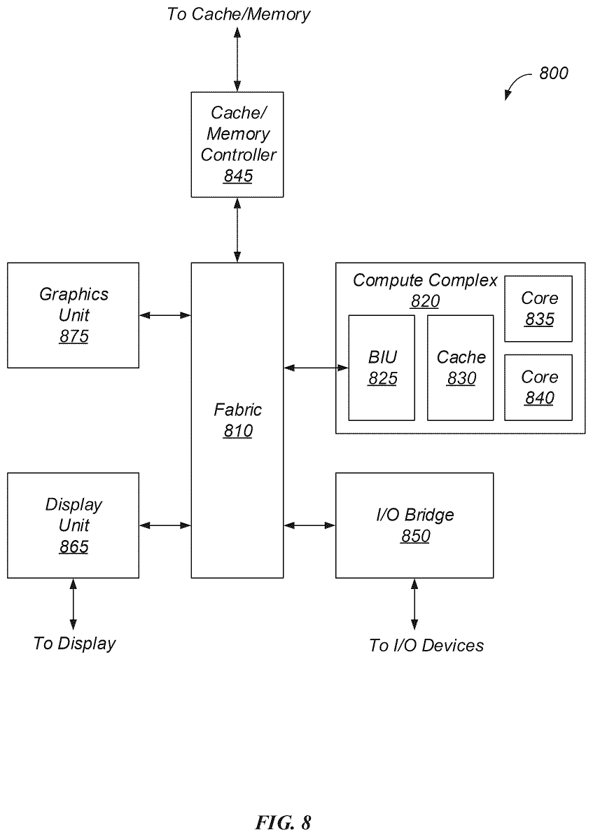

Referring now to FIG. 8, a block diagram illustrating an example embodiment of a device is shown. In some embodiments, elements of device 800 may be included within a system-on-a-chip. In some embodiments, device 800 may be included in a mobile device, which may be battery-powered. Therefore, power consumption by device 800 may be an important design consideration. In the illustrated embodiment, device 800 includes fabric 810, compute complex 820, input/output (I/O) bridge 850, cache/memory controller 845, graphics unit 875, and display unit 865. In some embodiments, device 800 may include other components (not shown) in addition to, or in place of, the illustrated components, such as video processor encoders and decoders, image processing or recognition elements (e.g., image processor circuit 502), computer vision elements, etc.

Fabric 810 may include various interconnects, buses, MUX's, controllers, etc., and may be configured to facilitate communication between various elements of device 800. In some embodiments, portions of fabric 810 may be configured to implement various different communication protocols. In other embodiments, fabric 810 may implement a single communication protocol, and elements coupled to fabric 810 may convert from the single communication protocol to other communication protocols internally.

In the illustrated embodiment, compute complex 820 includes bus interface unit (BIU) 825, cache 830, and cores 835 and 840. In various embodiments, compute complex 820 may include various numbers of processors, processor cores, and caches. For example, compute complex 820 may include 1, 2, or 4 processor cores, or any other suitable number. In one embodiment, cache 830 is a set associative L2 cache. In some embodiments, cores 835 and 840 may include internal instruction and data caches. In some embodiments, a coherency unit (not shown) in fabric 810, cache 830, or elsewhere in device 800, may be configured to maintain coherency between various caches of device 800. BIU 825 may be configured to manage communication between compute complex 820 and other elements of device 800. Processor cores, such as cores 835 and 840, may be configured to execute instructions of a particular instruction set architecture (ISA) which may include operating system instructions and user application instructions. These instructions may be stored in a computer readable medium such as a memory coupled to cache/memory controller 845 as discussed below.

As used herein, the term “coupled to” may indicate one or more connections between elements, and a coupling may include intervening elements. For example, in FIG. 8, graphics unit 875 may be described as “coupled to” a memory through fabric 810 and cache/memory controller 845. In contrast, in the illustrated embodiment of FIG. 8, graphics unit 875 is “directly coupled” to fabric 810 because there are no intervening elements.

Cache/memory controller 845 may be configured to manage transfer of data between fabric 810 and one or more caches and memories. For example, cache/memory controller 845 may be coupled to an L3 cache, which may, in turn, be coupled to a system memory. In other embodiments, cache/memory controller 845 may be directly coupled to a memory. In some embodiments, cache/memory controller 845 may include one or more internal caches. Memory coupled to cache/memory controller 845 may be any type of volatile memory, such as dynamic random access memory (DRAM), synchronous DRAM (SDRAM), double data rate (DDR, DDR2, DDR3, etc.) SDRAM (including mobile versions of SDRAMs such as mDDR3, etc., and/or low power versions of SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to cache/memory controller 845 may be any type of non-volatile memory such as NAND flash memory, NOR flash memory, nano RAM (NRAM), magneto-resistive RAM (MRAM), phase change RAM (PRAM), Racetrack memory, Memristor memory, etc. As noted above, this memory may store program instructions executable by compute complex 720 to cause the computing device to perform functionality described herein.

Graphics unit 875 may include one or more processors, e.g., one or more graphics processing units (GPUs). Graphics unit 875 may receive graphics-oriented instructions, such as OPENGL®, Metal®, or DIRECT3D® instructions, for example. Graphics unit 875 may execute specialized GPU instructions or perform other operations based on the received graphics-oriented instructions. Graphics unit 875 may generally be configured to process large blocks of data in parallel, and may build images in a frame buffer for output to a display, which may be included in the device or may be a separate device. Graphics unit 875 may include transform, lighting, triangle, and rendering engines in one or more graphics processing pipelines. Graphics unit 875 may output pixel information for display images. Graphics unit 875, in various embodiments, may include programmable shader circuitry which may include highly parallel execution cores configured to execute graphics programs, which may include pixel tasks, vertex tasks, and compute tasks (which may or may not be graphics-related).

Display unit 865 may be configured to read data from a frame buffer and provide a stream of pixel values for display. Display unit 865 may be configured as a display pipeline in some embodiments. Additionally, display unit 865 may be configured to blend multiple frames to produce an output frame. Further, display unit 865 may include one or more interfaces (e.g., MIPI® or embedded display port (eDP)) for coupling to a user display (e.g., a touchscreen or an external display).

I/O bridge 850 may include various elements configured to implement universal serial bus (USB) communications, security, audio, and low-power always-on functionality, for example. I/O bridge 850 may also include interfaces such as pulse-width modulation (PWM), general-purpose input/output (GPIO), serial peripheral interface (SPI), and inter-integrated circuit (I2C), for example. Various types of peripherals and devices may be coupled to device 800 via I/O bridge 850.

In some embodiments, device 800 includes network interface circuitry (not explicitly shown), which may be connected to fabric 810 or I/O bridge 850. The network interface circuitry may be configured to communicate via various networks, which may be wired, wireless, or both. For example, the network interface circuitry may be configured to communicate via a wired local area network, a wireless local area network (e.g., via Wi-Fi™), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi™ Direct), etc. In various embodiments, the network interface circuitry may provide device 800 with connectivity to various types of other devices and networks.

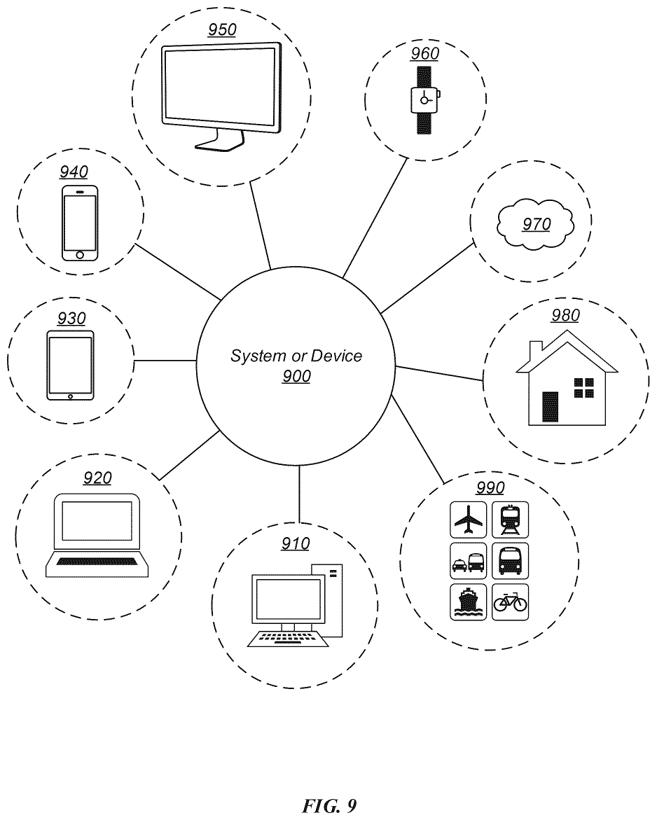

Turning now to FIG. 9, various types of systems that may include any of the circuits, devices, or systems discussed above are illustrated. System or device 900, which may incorporate or otherwise utilize one or more of the techniques described herein, may be utilized in a wide range of areas. For example, system or device 900 may be utilized as part of the hardware of systems such as a desktop computer 910, laptop computer 920, tablet computer 930, cellular or mobile phone 940, or television 950 (or set-top box coupled to a television).

Similarly, disclosed elements may be utilized in a wearable device 960, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 900 may also be used in various other contexts. For example, system or device 900 may be utilized in the context of a server computer system, such as a dedicated server or on shared hardware that implements a cloud-based service 970. Still further, system or device 800 may be implemented in a wide range of specialized everyday devices, including devices 880 commonly found in the home such as refrigerators, thermostats, security cameras, etc. The interconnection of such devices is often referred to as the “Internet of Things” (IoT). Elements may also be implemented in various modes of transportation. For example, system or device 900 could be employed in the control systems, guidance systems, entertainment systems, etc. of various types of vehicles 990.

The applications illustrated in FIG. 9 are merely exemplary and are not intended to limit the potential future applications of disclosed systems or devices. Other example applications include, without limitation: portable gaming devices, music players, data storage devices, unmanned aerial vehicles, etc.

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that programs a computing system to generate a simulation model of the hardware circuit, programs a fabrication system configured to produce hardware (e.g., an integrated circuit) that includes the disclosed circuitry, etc. Claims to such a storage medium are intended to cover, for example, an entity that produces a circuit design, but does not itself perform complete operations such as design simulation, design synthesis, circuit fabrication, etc.

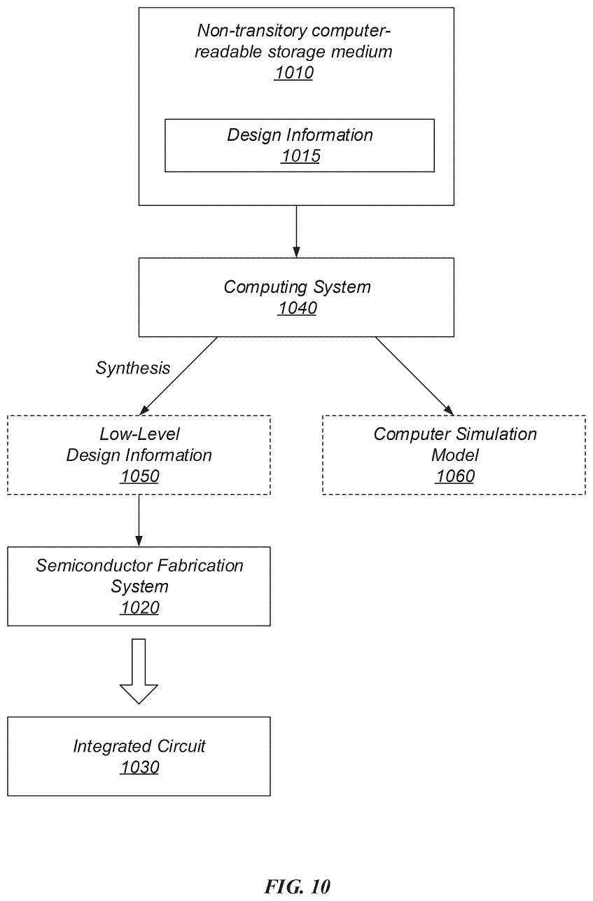

FIG. 10 is a block diagram illustrating an example of a non-transitory computer-readable storage medium that stores design information 1015, according to some embodiments. In the illustrated embodiment, computing system 1040 is configured to process design information 1015. This may include executing instructions included in design information 1015, interpreting instructions included in design information 1015, compiling, transforming, or otherwise updating design information 1015, etc. Therefore, design information 1015 controls computing system 1040 (e.g., by programming computing system 1040) to perform various operations discussed below, in some embodiments.

In the illustrated example, computing system 1040 processes design information 1015 to generate both computer simulation model of hardware circuit 1060 and low-level design information 1050. In other embodiments, computing system 1040 may generate only one of these outputs, may generate other outputs based on design information 1015, or both. Regarding computer simulation model of hardware circuit 1060, computing system 1040 may execute instructions of a hardware description language that includes register transfer level (RTL) code, behavioral code, structural code, or some combination thereof. The simulation model may perform the functionality specified by design information 1015, facilitate verification of the functional correctness of the hardware design, generate power consumption estimates, generate timing estimates, etc.

In the illustrated example, computing system 1040 also processes design information 1015 to generate low-level design information 1050 (e.g., gate-level design information, a netlist, etc.). This may include synthesis operations, as shown, such as constructing a multi-level network, optimizing the network using technology-independent techniques, technology dependent techniques, or both, and outputting a network of gates (with potential constraints based on available gates in a technology library, sizing, delay, power, etc.). Based on low-level design information 1050 (potentially among other inputs), semiconductor fabrication system 1020 is configured to fabricate integrated circuit 1030 (which may correspond to functionality of the computer simulation model of hardware circuit 1060). Note that computing system 1040 may generate different simulation models based on design information at various levels of description, including low-level design information 1050, design information 1015, and so on. The data representing low-level design information 1050 and computer simulation model of hardware circuit 1060 may be stored on non-transitory computer-readable storage medium 1010, or on one or more other media.

In some embodiments, low-level design information 1050 controls (e.g., programs) semiconductor fabrication system 1020 to fabricate integrated circuit 1030. Thus, when processed by the fabrication system, the design information may program the fabrication system to fabricate a circuit that includes various circuitry disclosed herein.

Non-transitory computer-readable storage medium 1010 may comprise any of various appropriate types of memory devices or storage devices. Non-transitory computer-readable storage medium 1010 may be an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash memory, magnetic media, e.g., a hard drive, or optical storage; registers, or other similar types of memory elements, etc. Non-transitory computer-readable storage medium 1010 may include other types of non-transitory memory as well, or combinations thereof. Accordingly, non-transitory computer-readable storage medium 1010 may include two or more memory media, which may reside in different locations for example, in different computer systems that are connected over a network.

Design information 1015 may be specified using any of various appropriate computer languages, including hardware description languages such as, without limitation: VHDL, Verilog, SystemC, System Verilog, RHDL, M, MyHDL, etc. The format of various design information may be recognized by one or more applications executed by computing system 1040, semiconductor fabrication system 1020, or both. In some embodiments, design information 1015 may also include one or more cell libraries that specify the synthesis, layout, or both of integrated circuit 1030. In some embodiments, design information 1015 is specified in whole, or in part, in the form of a netlist that specifies cell library elements and their connectivity. Design information discussed herein, taken alone, may or may not include sufficient information for fabrication of a corresponding integrated circuit. For example, design information may specify the circuit elements to be fabricated but not their physical layout. In this case, design information may be combined with layout information to actually fabricate the specified circuitry.

Integrated circuit 1030 may, in various embodiments, include one or more custom macrocells, such as memories, analog or mixed-signal circuits, and the like. In such cases, design information 1015 may include information related to included macrocells. Such information may include, without limitation, schematics capture database, mask design data, behavioral models, and device or transistor level netlists. Mask design data may be formatted according to graphic data system (GDSII), or any other suitable format.

Semiconductor fabrication system 1020 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 1020 may also be configured to perform various testing of fabricated circuits for correct operation.

In various embodiments, integrated circuit 1030 and computer simulation model of hardware circuit 1060 are configured to operate according to a circuit design specified by design information 1015, which may include performing any of the functionality described herein. For example, integrated circuit 1030 may include any of various elements shown in FIGS. 1-5. Further, integrated circuit 1030 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components. Similarly, stating “instructions of a hardware description programming language” that are “executable” to program a computing system to generate a computer simulation model does not imply that the instructions must be executed in order for the element to be met, but rather, specifies characteristics of the instructions. Additional features relating to the model (or the circuit represented by the model) may similarly relate to characteristics of the instructions, in this context. Therefore, an entity that sells a computer-readable medium with instructions that satisfy recited characteristics may provide an infringing product, even if another entity actually executes the instructions on the medium.

Note that a given design, at least in the digital logic context, may be implemented using a multitude of different gate arrangements, circuit technologies, etc. As one example, different designs may select or connect gates based on design tradeoffs (e.g., to focus on power consumption, performance, circuit area, etc.). Further, different manufacturers may have proprietary libraries, gate designs, physical gate implementations, etc. Different entities may also use different tools to process design information at various layers (e.g., from behavioral specifications to physical layout of gates).

Once a digital logic design is specified, however, those skilled in the art need not perform substantial experimentation or research to determine those implementations. Rather, those of skill in the art understand procedures to reliably and predictably produce one or more circuit implementations that provide the function described by design information 1015. The different circuit implementations may affect the performance, area, power consumption, etc. of a given design (potentially with tradeoffs between different design goals), but the logical function does not vary among the different circuit implementations of the same circuit design.

In some embodiments, the instructions included in design information 1015 provide RTL information (or other higher-level design information) and are executable by the computing system to synthesize a gate-level netlist that represents the hardware circuit based on the RTL information as an input. Similarly, the instructions may provide behavioral information and be executable by the computing system to synthesize a netlist or other lower-level design information included in low-level design information 1050. Low-level design information 1050 may program semiconductor fabrication system 1020 to fabricate integrated circuit 1030.

### CLAUSES

1. A system, comprising:
an image sensor configured to generate raw image data; and
an image processor circuit configured to:
receive the raw image data from an image sensor; and
generated updated image data using the raw image data;
wherein the image processor circuit includes an arithmetic-compare circuit configured to:
receive a first operand, a second operand, and a third operand, wherein at least one of the first operand, the second operand, or the third operand is based on the digital signal;
determine respective leading-zero counts for the first operand, the second operand, and the third operand;
generate a prediction of a first result of an arithmetic-compare operation using the respective leading-zero counts;
disable an execution of the arithmetic-compare operation based on the prediction; and
generate a final result using the prediction.

2. The system of any clause herein wherein the arithmetic-compare circuit is further configured to:
determine a first leading-one index using a first leading-zero count;
determine a second leading-one index using a second leading-zero count; and
determine a third leading-one index using a third leading-zero count.

3. The system of any clause herein, wherein to generate the prediction of the arithmetic-compare operation, the arithmetic-compare circuit is further configured to:
combine the first leading-one index and the second leading-one index to generate an index sum; and
perform a comparison of the index sum and the third leading-one index.

4. The system of any clause herein, wherein to disable the execution of the arithmetic-compare operation, the arithmetic-compare circuit is further configured to disable the execution of the arithmetic-compare operation using a second result of the comparison.

5. The system of any clause herein, wherein the arithmetic-compare circuit is further configured to:
perform the arithmetic-compare operation in response to determining the index sum is equal to the third leading-one index; and
generate the final result using a calculated result of the arithmetic-compare operation.

6. The system of any clause herein, wherein to perform the arithmetic-compare operation, the arithmetic-compare circuit is further configured to:
multiply the first operand and the second operand to generate a product; and
compare the product and the third operand to generate the calculated result.

7. The system of any clause herein, wherein to perform the arithmetic-compare operation, the arithmetic-compare circuit is further configured to:
divide the first operand by the second operand to generate a quotient; and
compare the quotient and the third operand to generate the calculated result.

The present disclosure includes references to an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent claims that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third,” when applied to a feature, do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors, or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation-[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, a circuit, or a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112 (f) for that claim element. Should Applicant wish to invoke Section 112 (f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), a functional unit, a memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement of such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as a structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used to transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits, or portions thereof, may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

What is claimed is:

1. An apparatus, comprising:
a first logic circuit configured to:
determine respective leading-zero counts for a first operand, a second operand and a third operand; and
predict, using the respective leading-zero counts for the first operand, the second operand, and the third operand, a first result of an arithmetic-compare operation; and
a second logic circuit configured to disable, using the first result, an execution of the arithmetic-compare operation.

2. The apparatus of claim 1, wherein the first logic circuit is further configured to:
determine a first leading-one index using a first leading-zero count for the first operand;
determine a second leading-one index using a second leading-zero count for the second operand; and
determine a third leading-one index using a third leading-zero count for the third operand.

3. The apparatus of claim 2, wherein to predict the first result of the arithmetic-compare operation, the first logic circuit is further configured to:
combine the first leading-one index and the second leading-one index to generate an index sum; and
perform a first comparison of the index sum and the third leading-one index.

4. The apparatus of claim 3, wherein the second logic circuit is further configured to disable the execution of the arithmetic-compare operation using a second result of the first comparison.

5. The apparatus of claim 3, wherein the first logic circuit is configured to perform a second comparison of the index sum and the third leading-one index, wherein the second logic circuit is configured, in response to a determination that the index sum and the third leading-one index are equal, to perform the arithmetic-compare operation to generate a calculated result, and further comprising an output circuit configured, in response to the determination that the first leading-one index and the second leading-one index are equal, to select the calculated result to generate a final result.

6. The apparatus of claim 1, wherein to perform the arithmetic-compare operation, the second logic circuit is further configured to:
multiply the first operand and the second operand to generate a product; and
compare the product and the third operand to generate a calculated result.

7. A method, comprising:
receiving, by an arithmetic-compare circuit, a first operand, a second operand, and a third operand, wherein the arithmetic-compare circuit includes a first logic circuit and a second logic circuit;
determining, by the first logic circuit, respective leading-zero counts for the first operand, the second operand, and the third operand;
generating, by the first logic circuit, a prediction of a first result of an arithmetic-compare operation using the respective leading-zero counts;
disabling, by the second logic circuit, an execution of the arithmetic-compare operation based on the prediction; and
generating, by the arithmetic-compare circuit, a final result using the prediction.

8. The method of claim 7, further comprising:
determining, by the first logic circuit, a first leading-one index using a first leading-zero count;
determining, by the first logic circuit, a second leading-one index using a second leading-zero count; and
determining, by the first logic circuit, a third leading-one index using a third leading-zero count.

9. The method of claim 8, wherein generating the prediction includes:
combining, by the first logic circuit, the first leading-one index and the second leading-one index to generate an index sum; and
performing, by the first logic circuit, a comparison of the index sum and the third leading-one index.

10. The method of claim 9, wherein disabling the execution of the arithmetic-compare operation includes disabling, by the second logic circuit, the execution of the arithmetic-compare operation using a second result of the comparison.

11. The method of claim 9, further comprising:
performing, by the first logic circuit, a comparison of the index sum and the third leading-one index;
performing, by the second logic circuit, the arithmetic-compare operation in response to determining the index sum is equal to the third leading-one index; and
generating, by the arithmetic-compare circuit, the final result using a calculated result of the arithmetic-compare operation.

12. The method of claim 11, wherein performing the arithmetic-compare operation includes:
multiplying, by the second logic circuit, the first operand and the second operand to generate a product; and
comparing, by the second logic circuit, the product and the third operand to generate the calculated result.

13. The method of claim 11, wherein performing the arithmetic-compare operation includes:
dividing, by the second logic circuit, the first operand by the second operand to generate a quotient; and
comparing, by the second logic circuit, the quotient and the third operand to generate the calculated result.

14. An apparatus, comprising:
a first logic circuit configured to:
determine respective signs of a first operand, a second operand and a third operand; and
predict, using a first sign of the first operand and a second sign of the second operand, a sign of an arithmetic portion of an arithmetic-compare operation;
perform a comparison of the sign of the arithmetic portion of the arithmetic-compare operation and a third sign of the third operand; and
a second logic circuit configured to disable, using a result of the comparison, an execution of the arithmetic-compare operation.

15. The apparatus of claim 14, wherein the first logic circuit is further configured to predict a first result of the arithmetic-compare operation in response to a determination that the sign of the arithmetic portion of the arithmetic-compare operation is positive and that the third sign of the third operand is negative.

16. The apparatus of claim 14, wherein the first logic circuit is further configured to predict a first result of the arithmetic-compare operation in response to a determination that the sign of the arithmetic portion of the arithmetic-compare operation is negative and that the third sign of the third operand is positive.

17. The apparatus of claim 14, wherein the first logic circuit is further configured, in response to a determination that that the sign of the arithmetic portion of the arithmetic-compare operation is positive and that the third sign of the third operand is positive, to:
determine respective leading-zero counts for the first operand, the second operand and the third operand; and
predict, using the respective leading-zero counts for the first operand, the second operand, and the third operand, a first result of the arithmetic-compare operation.

18. The apparatus of claim 14, wherein the first logic circuit is further configured, in response to a first determination that that the sign of the arithmetic portion of the arithmetic-compare operation is negative and that the third sign of the third operand is negative, to:
determine, in response to a second determination that the first sign of the first operand is positive, a leading-zero count for the first operand;
determine, in response to a third determination that the second sign of the second operand is negative, a first leading-one count for the second operand;
determine a second leading-one count for the third operand; and
predict, using the leading-zero count, the first leading-one count, and the second leading-one count, a first result of the arithmetic-compare operation.

19. The apparatus of claim 14, wherein the first logic circuit is further configured, in response to a first determination that that the sign of the arithmetic portion of the arithmetic-compare operation is negative and that the third sign of the third operand is negative, to:
determine, in response to a second determination that the first sign of the first operand is negative, a first leading-one count for the first operand;
determine, in response to a third determination that the second sign of the second operand is positive, a leading-zero count for the second operand;
determine a second leading-one count for the third operand; and
predict, using the leading-zero count, the first leading-one count, and the second leading-one count, a first result of the arithmetic-compare operation.

20. The apparatus of claim 14, wherein the first logic circuit is further configured, in response to a first determination that that the sign of the arithmetic portion of the arithmetic-compare operation is positive and that the third sign of the third operand is positive, to:
determine, in response to a second determination that the first sign of the first operand is negative, a first leading-one count for the first operand;
determine, in response to a third determination that the second sign of the second operand is negative, a second leading-one count for the second operand;
determine a leading-zero count for the third operand; and
predict, using the leading-zero count, the first leading-one count, and the second leading-one count, a first result of the arithmetic-compare operation.
